(19) United States
(12) Patent Application Publication
(10) Pub. No.: US 2022/0315723 A1
(43) Pub. Date: Oct. 6, 2022

(54) MOLDING OF BEAD FOAM POLYESTERS

(71) Applicant: Lifoam Industries, LLC, Greer, SC (US)

(72) Inventors: Saumitra Bhargava, Clarksville, MD (US); Jonathan Godfrey, Joppa, MD (US); Walter Chris Mercy, Felton, PA (US)

(21) Appl. No.: 17/656,700

(22) Filed: Mar. 28, 2022

Related U.S. Application Data
(60) Provisional application No. 63/170,953, filed on Apr. 5, 2021.

(51) Int. Cl. C08J 9/228

(52) U.S. Cl. CPC C08J 9/228; C08J 2203/10; C08J 2367/04

(57) ABSTRACT

Methods of making molded foam articles. The methods include introducing steam into a mold simultaneous to filling the mold with foam particles. The method can be performed faster and with a lower ΔT than conventional molding processes, permitting faster turn-around to the production of subsequent molded articles. The molded articles produced by the method can have thicker side walls and improved foam particle fusion as compared to conventional molding processes.

### CROSS-REFERENCE TO RELATED APPLICATIONS

This disclosure claims priority to and the benefit of U.S. Provisional Application No. 63/170,953, filed Apr. 4, 2021, which is hereby incorporated by reference herein in its entirety.

### FIELD OF THE DISCLOSURE

This disclosure relates generally to molded polyester bead foam and methods of making molded polyester bead foam articles and, in particular, relates to thicker and stronger molded bead foam polyesters and methods of making thicker and stronger molded bead foam polyester articles.

### BACKGROUND

Molded bead foam polyester articles, are being commercialized as expandable polystyrene (EPS) replacement in thermal insulation and/or impact protection applications. EPS is a widely used bead foam material having a well-established manufacturing process that is easily reproducible. EPS molding is the oldest and fastest (with respect to cycle time) molding process commercially practiced. Other bead foams have gained popularity in recent years, particularly recyclable and biodegradable bead foams formed out of, for example, polylactic acid and/or polyethylene terephthalate.

Conventional bead foam molding involves injecting foam particles into a mold, followed by injecting the mold with steam, subjecting the exterior of the mold to cooling water, followed by subjecting the mold to a negative pressure cycle. Due to control systems in conventional molding systems, it is impossible to pass steam through the mold simultaneous to either filling the mold with foam particles or to subjecting the mold to a negative pressure cycle. As a result, steam penetration into the center of the bead foam mass can vary widely depending on the geometry of the mold, resulting in poor uniformity of foam particle fusion at varying locations within the article. A molded polyester article having poor fusion of the foam particles will subsequently have poor thermal and impact insulation properties.

To prevent poor fusion of foam particles, conventional bead foam molding limits the thickness of molded polyester articles. Thus, manufacturers and consumers must choose between increased thickness of molded polyester articles and the structural integrity of those articles.

Previous attempts to modify the conventional bead foam molding process include removal of any introduction of steam in favor of pre-heating the mold prior to foam particle introduction, as described in U.S. Pat. No. 10,688,698 to Lifoam Industries LLC. That method describes the making of a molded foam article comprising homopolymers, graft polymers, or copolymer of polylactic acid through the elimination of steam or other heating medium.

Accordingly, improved methods of molding polyesters are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a chart depicting flexural strength of molded articles as described in the present disclosure.

FIG. 2 is a chart depicting deflection force of molded articles as described in the present disclosure.

FIG. 3 is a side view in cross-section of molded articles produced as described in the present disclosure.

FIG. 4 is a chart depicting deflection force of molded articles as described in the present disclosure.

FIG. 5 is a chart depicting deflection force of molded articles as described in the present disclosure.

### DETAILED DESCRIPTION

Methods of making molded polyesters are provided herein including methods of making thicker molded polyesters having improved bead fusion compared to molded polyesters produced using conventional methods, such as molding of expandable polystyrene (EPS). In particular, it has been discovered that simultaneously injecting steam into a mold cavity during foam particle introduction improves wetting of the foam particles, thereby improving foam particle fusion. Furthermore, in some embodiments, the method includes pulling a slight negative pressure cycle simultaneous to steam injection and foam particle introduction, thereby permitting greater control over the temperature of the foam particles before and during molding. The methods of making molded polyesters provided herein may be used to produce molded polyester articles having any suitable thickness, including thicknesses of 2.5 inches (63 mm) or greater with fusion of the foam particles equal to or superior to molded polyester articles of lesser thicknesses.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Methods of molding polyesters are disclosed herein. In some preferred embodiments, the method includes (i) wetting and heating foam particles introduced into a mold for an article without foam particle fusion. In some embodiments, the method includes (ii) applying a negative pressure cycle in which the foam particles are expanded and fused together to form the article, and then (iii) removing the molded foam article from the mold.

As used herein, “expansion” of foam particles refers to the process by which foam particles enlarge in size, reducing their density while growing malleable. This is typically accomplished by wetting the foam particles in the presence of heat and/or slight negative pressure cycle. Since foam particles suitable for molding are typically spherical or cylindrical and include a blowing agent that facilitates expansion, the expansion of the foam particles permits neighboring foam particles to fill in spaces between neighboring particles, regardless of the particles' shapes. The expansion of the foam particles is necessary for successful molding. The beginning of the expansion of the foam particles marks the beginning of the molding process, so premature expansion of the foam particles before the foam particles are situated in the mold may result in poor or unsuccessful molding, depending on the degree of expansion prior to being situated.

As used herein, “fusion” of the foam particles refers to the process by which foam particles bond and adhere to one another. Without intending to be bound by any particular theory, foam particle fusion may be accomplished by some intermingling of polymer chains at the surfaces of foam particles in contact with one another, otherwise known as the “bead-to-bead interface.” Following intermingling of polymer at the bead-to-bead interface, the foam particles require more than a nominal degree of force to be separated. Thus, a molded foam article is comprised of fused foam particles. A molded foam article retains a shape as a result of the fusion of the foam particles comprising the molded foam article. The “degree of fusion” between particles correlates to how much force is required to separate the foam particles. Without intending to be bound by any particular theory, the degree of fusion is also affected by the uniformity of foam particle fusion throughout a molded article. A greater degree of fusion corresponds to a greater amount of force require to separate the foam particles. There is no standardized test for measuring a degree of fusion, but properties such as flexural strength and resistance to compression depend on the degree of fusion between the foam particles. Thus, the degree of fusion may be approximated through other tests designed to measure flexural strength or deflection force, allowing for a qualitative comparison among samples of molded articles to determine which possess “better fusion” of the foam particles in the molded articles.

One such test for measuring fusion is referred to herein as the “cutting test,” in which a molded foam article is cut with a non-serrated utility knife (e.g., a razor blade) to reveal the innermost foam particles. Upon cutting, some of the innermost foam particles are revealed to be loose and separated from the molded foam article. If the inner surface of the molded foam article is colored, such as through the application of a marker, uncolored areas represent voids that previously included poorly fused foam particles. A comparison of the amount of uncolored space between two samples, such as through surface metrology analysis, permits qualitative comparison of the fusion of the foam particles between the samples.

Another test that approximates the degree of fusion is the standard test specified by ASTM C203, which measures the flexural strength of molded foam articles. Without intending to be bound by any particular theory, it is believed that molded foam particles that are fused more uniformly require more force to pull apart and break, after normalizing for density, while loose foam particles would separate more easily. Molded foam particles requiring greater force to pull apart and break correspond to a greater measured flexural strength, while loose foam particles that separate easily correspond to a lesser measured flexural strength. Thus, the flexural strength for a molded foam article with a greater degree of fusion would be greater than the flexural strength for a molded foam article having the same density and constructed from the same material having poorer fusion between the foam particles. Without intending to be bound by any particular theory, it is believed that, in addition to the method of manufacture, both the density and chemical formulation of the foam particles influence the flexural strength of molded foam article. For example, an expandable polyethylene terephthalate (ePET) molded article having a density of 0.05 g/cm³ is expected to have a higher flexural strength than (1) an expandable polylactic acid (ePLA) molded article having a density of 0.02 g/cm³ (illustrating a difference in chemical composition), or (2) an ePET molded article having a density of 0.02 g/cm³ (illustrating a difference in density), even if the ePET molded article having a density of 0.05 g/cm³ has poorer degree of fusion. Thus, in some embodiments, the methods described herein have been shown to produce molded articles having improved degree of fusion as compared to molded articles of the same density and same chemical composition produced by conventional methods. In some embodiments, the molded foam article produced by the method has a greater flexural strength than a foam article molded using a conventional process, as measured by ASTM C203.

Another test that approximates the degree of fusion is the standard test specified by ASTM D3575-14, which measures the compressibility of molded foam articles by measuring the deflection and recovery of a molded foam article through the application of compressive force. Without intending to be bound by any particular theory, it is believed that foam particles that are fused more uniformly exhibit a stronger compression strength while loose beads would simply give way under compressive force. Thus, the compression strength for a molded foam article with a greater degree of fusion would be greater than the compression strength for a molded foam article having poorer fusion between the foam particles. In some embodiments, the molded foam article produced by the method has a greater compression strength than a foam article molded using a conventional process, as measured by ASTM D3575-14.

As used herein, applying a “negative pressure” refers to subjecting the system to a slight negative pressure. As used herein, a “slight negative pressure” refers to subjecting the system to a negative pressure of from about −1.5 inHg (−5.08 kPa) to about −8 inHg (−27.09 kPa), such as from about −0.5 inHg (−1.69 kPa) to about −2 inHg (−6.77 kPa). Conventional EPS molding processes typically subject the mold to a negative pressure of −20 inHg (−67.73 kPa) to −28 inHg (−94.82 kPa).

As used herein, “without foam particle fusion” refers to foam particles having no, or only a nominal degree of, adhesion to neighboring foam particles, as indicated for example by having no more than 5% of the separation force required following completion of the molding process.

As used herein, a “mold” refers to a cavity having the shape of the molded foam article. The mold may have two or more separable parts that facilitate opening the mold for removal of the molded foam article. The separable parts of the mold may have a plurality of apertures configured to permit the passage of gases, such as for the introduction of steam or the removal of air, steam, and/or other gases through the application of a negative pressure cycle.

In some embodiments, the method is effective to yield a molded article which has greater fusion uniformity than a foam article molded using a conventional process. That is, the degree to which foam particles are fused together within a molded article is consistent among different regions within the molded article. This is an advantageous result of the manner in which the foam particles are heated and wetted in the presently disclosed methods.

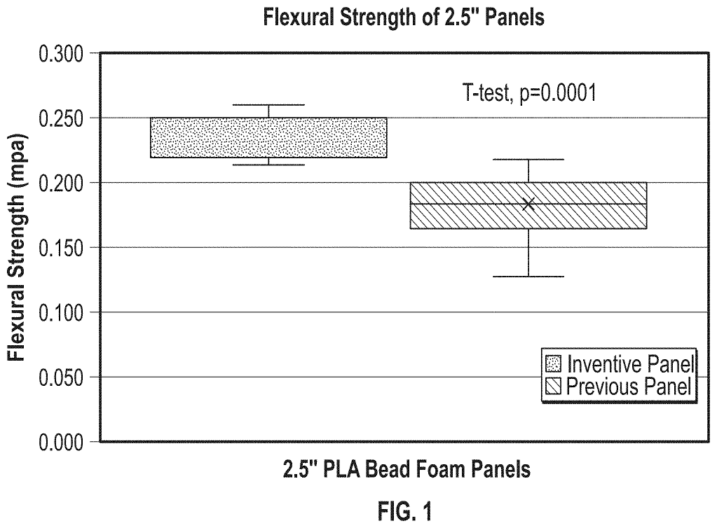

As described previously, the use of ASTM C203 and/or ASTM D3575-14 may allow approximation of the uniformity of foam particle fusion. When either or both of these tests are performed on multiple samples from the same molded article, the uniformity of foam particle fusion may be approximated by evaluating the uniformity of the flexural strength and deflection force measurements. The error bars in the charts in FIGS. 1, 2, 4, and 5 represent the uniformity of the flexural strength or deflection force, and are indicative of the uniformity of foam particle fusion in those molded articles.

In some embodiments, the method includes introducing foam particles into the mold while simultaneously introducing steam into the mold. In conventional particle foam molding processes, control systems prevent users and/or the equipment from introducing steam during the particle filling step. Instead, users must first fill the mold with foam particles, and subsequently introduce steam. Such control systems are in place to prevent premature introduction of steam which may result in premature expansion of the foam particles, as described previously. Furthermore, introducing steam during the filling process results in some steam escaping the mold without wetting or heating the foam particles, resulting in some steam being “wasted.” However, it has been surprisingly found that introducing steam during the particle filling step, such as through the implementation of custom software, hardware, actuators, valves, or a combination thereof, can improve wetting of the foam particles compared to the introduction of steam after the foam particles have been introduced and settled within the mold. This simultaneous steam introduction during particle introduction unexpectedly permits the molding of thicker molded foam articles while maintaining or improving fusion of the foam particles as compared to conventional molding processes. Furthermore, the process consumes less steam and requires less energy than a conventional process, despite the possibility of some steam being lost during bead fill and the bead wetting process.

In some embodiments, the method includes injecting steam into the mold while applying the slight negative pressure cycle in which the foam particles are expanded and fused together to form the article.

In some embodiments, the method includes applying slight negative pressure cycle to the mold simultaneously with the introduction of the foam particles and the steam. In conventional particle foam molding processes, control systems prevent users and/or the equipment from applying slight negative pressure cycle during the particle filling step. Instead, users must first fill the mold with foam particles, subsequently introduce steam, and subsequently apply negative pressure cycle. Such control systems are in place to prevent premature application of slight negative pressure cycle which may result in accelerated consumption of steam. However, it has been surprisingly found that applying slight negative pressure cycle during the introduction of foam particles and steam, such as through the implementation of custom software, hardware, actuators, valves, or a combination thereof, can improve wetting of the foam particles by better controlling the temperature of the foam particles. Without intending to be bound by any particular theory, it is believed that the simultaneous application of slight negative pressure cycle while the foam particles and steam are introduced results in a greater number of foam particles to be wetted while minimizing the increase in temperature that results from introducing steam. Thus, the foam particles are wetted while preventing the premature expansion of the foam particles. This simultaneous slight negative pressure cycle application and steam introduction during particle introduction unexpectedly permits the molding of thicker molded foam articles while maintaining or improving fusion of the foam particles.

In some embodiments, wetting and heating foam particles introduced into the mold includes (a) introducing the foam particles into the mold, and then (b) introducing steam into the mold while venting the mold, wherein the venting is effective to prevent the foam particles from collapsing. In conventional particle foam molding processes, control systems prevent users and/or the equipment from introducing steam while venting the system. Instead, conventional molding equipment is configured to be mounted on a steam chest so that steam can be introduced into the mold without permitting steam to escape, allowing steam to accumulate and surround the mold. These conventional systems prevent venting during steam introduction because some steam will escape the mold without wetting or heating the foam particles, resulting in some steam being “wasted.” However, it has been surprisingly found that venting the mold while introducing steam, such as through the implementation of custom software, hardware, actuators, valves, or a combination thereof, can improve wetting of the foam particles without excessive heating of the foam particles. Without intending to be bound by any particular theory, it is believed that venting the mold during steam introduction allows for greater control over the temperature of the foam particles so that the foam particles are prevented from collapsing or overheating.

As used herein, “collapsing” of the foam particles refers to the phenomenon in which the foam particles expand for an extended period of time, passing through the regime of decreasing density characteristic of expandable foams and entering a regime of increasing density. The increase in density results from the complete degas of a blowing agent, marking the end of the foam particle's ability to expand further. When the blowing agent dissipates, the foam particle begins to decrease in size, resulting in an increased density. Foam particles that have collapsed are no longer suitable for molding because they lose the ability to fill in gaps that exist between neighboring foam particles.

In some embodiments, the steam introduced into the mold heats the mold to a first temperature. After the mold has been filled with foam particles, the mold is subsequently cooled to a second temperature during the negative pressure cycle. In some embodiments, the first temperature is less than 30° C. higher than the second temperature. In some embodiments, the first temperature is about 10° C. higher than the second temperature. In conventional molding systems that lack simultaneous steam introduction and particle filling, steam introduction during particle filling and applying slight negative pressure cycle, steam introduction during particle filling and venting, or a combination thereof, the introduction of steam results in a temperature increase of 40° C. or greater. For example, a conventional expandable polypropylene (EPP) molding process has a ΔT of between 100-160° C. depending on the machine and/or process. Conventional expandable polystyrene (EPS) molding processes have a ΔT of 45-60° C. depending on the machine and/or process. Thus, it has been unexpectedly discovered that simultaneous steaming, particle filling, slight negative pressure cycle application, and/or venting results in a reduction in the ΔT of the system by greater than 50%. By reducing the temperature increase of the system, the molding process may be accomplished in a shorter period, and with lower energy consumption in the form of less steam consumed, than as compared to processes that use a conventional molding system. Furthermore, a reduced ΔT reduces the time necessary to prepare the mold for a subsequent molding process, reducing the turn-around time for producing multiple molded articles.

The molded foam articles produced by the method may have any suitable thickness greater than 0.75 inches (19 mm), including thickness of around 3 inches (76.2 mm), around 6 inches (154 mm), around 12 inches (305 mm), greater than 12 inches (305 mm), or any thickness therebetween. In some embodiments, the molded foam article produced by the method has a thickness in at least one dimension of 0.75 inches (19 mm) or greater. In some embodiments, the molded foam article produced by the method has a thickness of at least 2.5 inches (63 mm) in at least one dimension. As used herein, the “thickness” of a molded foam article refers to the smallest dimension of the molded foam article. In other words, a molded foam article in the form of a monolithic panel has a relatively large length and width, but a relatively small thickness. For example, a molded foam panel may have a length of 8 inches (203 mm), a width of 10 inches (254 mm), and a thickness of 2.5 inches (63.5 mm). Another example of a molded foam article is a molded box having five sides. The box may be 8 inches (203 mm)×6 inches (152 mm)×10 inches (254 mm) with a side-wall thickness of 1.5 inches (38 mm). In conventional molding systems, the ability to introduce steam to wet and heat the foam particles only after they have been introduced into the mold has limited the thickness of the molded foam article because steam is unable to penetrate more than approximately 1 inch (25 mm) into the foam particle mass in any direction. For this reason, the majority of molded foam articles produced by conventional processes have a thickness of between 1-2.5 inches (25-63 mm). Thus, it has been unexpectedly discovered that simultaneous steaming, particle filling, slight negative pressure cycle application, and/or venting allows for molding foam articles having thicknesses greater than those possible in conventional molding systems.

In some embodiments, the overall molding time of the method for molding the foam article is at least 50% less than an overall molding time of a conventional expandable polystyrene molding process. As used herein, the “overall molding time” of a process involves every step from closure of the mold to opening of the mold, including foam particle introduction, steam introduction, and application of negative pressure cycle. The time prior to closure of the mold can vary widely based on the equipment used, such as the equipment used for actuating the mold halves, and on the geometry of the molded article. Conventional molding processes include a number of sequential steps, including initial steaming, particle filling, hydraulics, direct steaming, cooling, and stabilization/hold. Conventional expandable polystyrene (EPS) molding processes, considered the “fastest” commercial molding processes, have an overall molding time of around 60-65 seconds. The method described herein has an overall molding time that is at least 50% less than the overall molding time of an EPS process for the same geometry. The method described herein has an overall molding time of around 18-22 seconds or less.

In some embodiments, the steam is introduced into the mold at an angle tangential to a side of the mold so as to agitate the foam particles with the mold and improve wetting of the foam particles. For example, a mold having a substantially cylindrical shape may have steam introduced at an angle tangential to the circular cross-section of the cylindrical shape, resulting in a tortious effect on the foam particles so that they rotate within the mold.

In some embodiments, the foam particles comprise homopolymers, graft polymers, blends or copolymers of poly(butylene succinate), poly(ethylene terephthalate), poly(lactic acid), poly(poly(hydroxy butyrate)), poly(butylene terephthalate), poly(caprolactone), poly(butylene adipate terephthalate), poly(hydroxy alkonate), or blends thereof. In some embodiments, the foam particles include low crystallinity poly(lactic acid) foam beads. Conventional expandable polystyrene molding machines have been adapted to mold foam articles comprising materials other than polystyrene provided those materials have high crystallinity, or provided the crystallinity of those materials is increased prior to foaming/expansion. It has been unexpectedly discovered that simultaneous steaming, particle filling, vacuum application, and/or venting allows for the molding of foam articles comprising materials with lower crystallinities previously incapable of molding.

### EXAMPLES

The invention may be further understood with reference to the following non-limiting examples.

### Example 1: Comparison with Previous Molding Process for 2.5″ Panels

Molded articles were produced as described herein and compared to molded articles produced by the method described in U.S. Pat. No. 10,688,698 to Lifoam Industries LLC. All tested molded articles were formed from poly(lactic acid). All tested molded articles were 16.2 inches (411.5 mm)×13.2 inches (335 mm)×2.5 inches (63.5 mm). The molded articles produced as described herein were molded in a Kurtz Ersa Corporation K68 HP5 Top-Line molding machine, available commercially from Kurtz Ersa Corporation, Kreuzwertheim, Germany. The molding machine was modified with custom software to enable the simultaneous introduction of steam during foam particle introduction. The process parameters are presented in Table 1.

As shown in Table 1, the method as described herein may produce molded articles 40% faster than the method described in U.S. Pat. No. 10,688,698. Less time is needed for steam because no steam is used to pre-heat the mold in the present method. Furthermore, the ΔT of the present method is 45% lower than the method described in U.S. Pat. No. 10,688,698, representing lower energy consumption, faster molding, and faster turn-around to molding of subsequent articles.

FIG. 1 is a chart depicting the flexural strength of the 2.5 inch (63.5 mm) panels produced in this Example, as measured by ASTM C203. The panels produced by the present method had greater flexural strength and less variability among samples, representing improved fusion of the foam particles in the molded article produced by the present method compared to molded articles produced as described in U.S. Pat. No. 10,688,698. Furthermore, the differences between the two are statistically significant as indicated by a p-value less than 0.05.

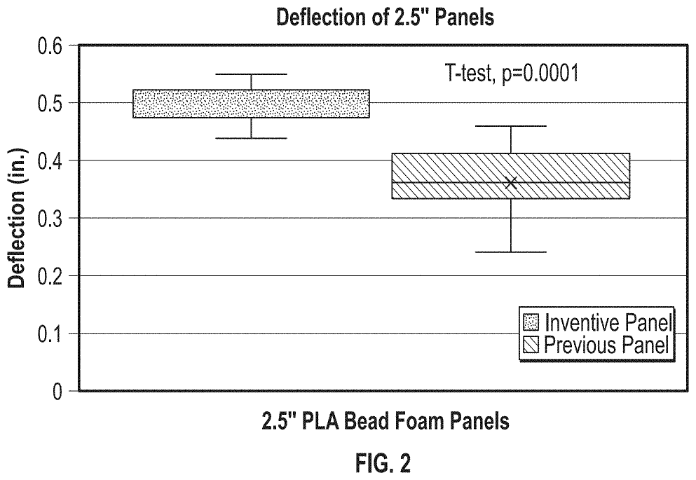

FIG. 2 is a chart depicting the deflection force of the 2.5 inch (63.5 mm) panels produced in this Example, as measured by ASTM D3575-14. The panels produced by the present method withstood greater deflection force with less variability among samples, again representing improved fusion of the foam particles in the molded article produced by the present method compared to molded articles produced as described in U.S. Pat. No. 10,688,698. Furthermore, the differences between the two are statistically significant as indicated by a p-value less than 0.05.

TABLE 1
Process Parameters for Comparison with U.S. Pat. No. 10,688,698

| U.S. Pat. No. 10,688,698 Process | | | New Process | | | |
|---|---|---|---|---|---|---|
| | Time | % of | | Time | % of | Comparison |
| Step | (sec) | Total | Step | (sec) | Total | Vs US '698 |
| Steam Before | 3 | 9% | Steam Before | 0 | 0% | −3.0 sec |
| Fill | 3 | 9% | Steam + Fill | 2.5 | 13% | −0.5 sec |
| Hydraulics | 6.8 | 21% | Hydraulics | 6.8 | 35% | +0.0 sec |
| Direct Steam | 1.2 | 4% | Direct Steam | 1.2 | 6% | +0.0 sec |
| Open to | 2 | 6% | Open to | 1.2 | 6% | −0.8 sec |
| Atmosphere | | | Atmosphere | | | |
| Stabilization | 15 | 47% | Stabilization | 7 | 36% | −8.0 sec |
| Cycle Pause | 1 | 3% | Cycle Pause | 1 | 5% | +0.0 sec |
| Total Time | 32 | | Total Time | 19.7 | | −12.3 sec |
| Total Steaming Time | 4.2 | | Total Steaming Time | 3.7 | | −0.5 sec |
| `Max Temp (° C.) | 98.7 | | Max Temp (° C.) | 96.0 | | −2.7° C. |
| Min Temp (° C.) | 81.1 | | Min Temp (° C.) | 86.0 | | 4.9° C. |
| AT (° C.) | 17.6 | | ΔT (° C.) | 10.0 | | −7.6° C. |

### Example 2: Comparison with Previous Molding Process for 1.5″ Panels

Molded articles were produced as described herein and compared to molded articles produced by the method described in U.S. Pat. No. 10,688,698 to Lifoam Industries LLC. For this example, the mold was vented during steam introduction. All tested molded articles were formed from poly(lactic acid). All tested molded articles were 9 inches (229 mm)×9 inches (229 mm)×1.5 inches (38 mm). The molded articles produced as described herein were molded in a Kurtz Ersa Corporation K68 HP5 Top-Line molding machine, available commercially from Kurtz Ersa Corporation, Kreuzwertheim, Germany. The molding machine was modified with custom software to enable the simultaneous venting during introduction of steam and foam particle introduction.

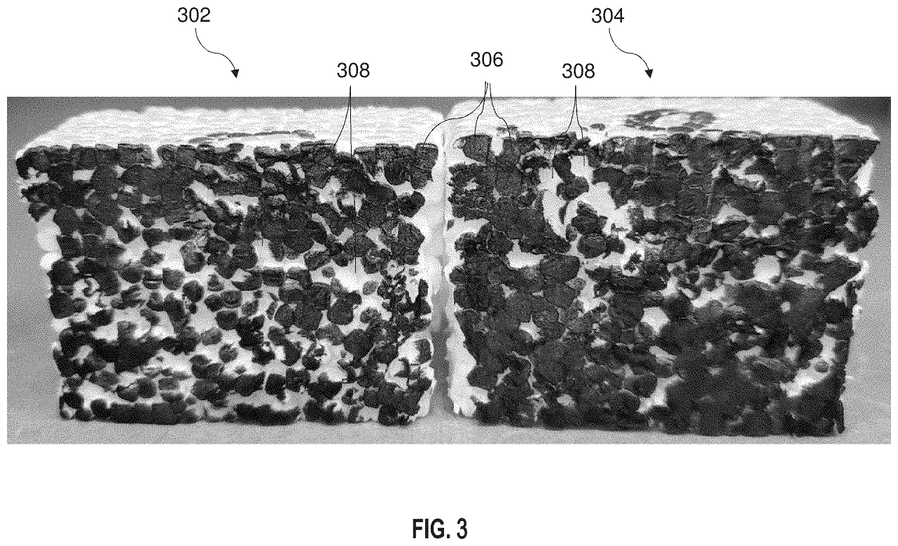

The panels were tested 96 hours after manufacture. The panels were conditioned at 73° F. (23° C.) at 50% relative humidity for 24 hours, and then analyzed using the cutting test as described herein. The results of the cutting test are shown in FIG. 3. FIG. 3 depicts the inside of a molded article 302 produced by the method described in U.S. Pat. No. 10,688,698 and the inside of a molded article 304 produced by the method described herein, with simultaneous venting during introduction of steam and particle introduction. Molded foam particles 306 are distinguishable from neighboring particles. As a result of the cutting test, some foam particles are dislodged and leave behind voids 308, illustrating the degree of fusion between the foam particles. FIG. 3 illustrates that the degree of fusion in the molded article 304 produced by the method described herein is qualitatively improved over the molded article 302 produced by the method described in U.S. Pat. No. 10,688,698.

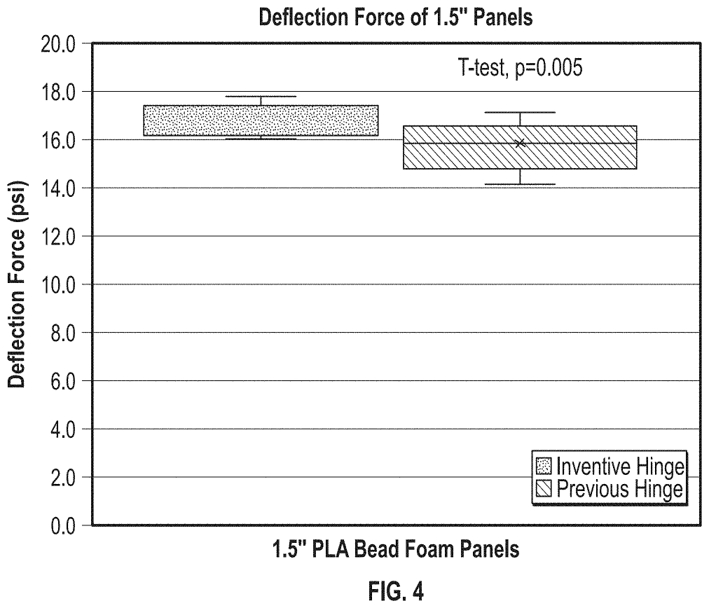

FIG. 4 is a chart depicting the deflection force of the 1.5 inch (38 mm) panels produced in this Example, as measured by ASTM D3575-14. The panels produced by the present method withstood greater deflection force with less variability among samples, again representing improved fusion of the foam particles in the molded article produced by the present method compared to molded articles produced as described in U.S. Pat. No. 10,688,698. Furthermore, the differences between the two are statistically significant as indicated by a p-value of about 0.05.

### Example 3: Comparison with Previous Molding Process and with EPS Process

Molded articles were produced as described herein and compared to molded articles produced by the method described in U.S. Pat. No. 10,688,698 to Lifoam Industries LLC and to molded articles produced using a conventional EPS process. The molded articles produced using the method described herein and described in U.S. Pat. No. 10,688,698 were formed from poly(lactic acid), while the conventional EPS process used expandable polystyrene. All tested molded articles were in the form of an open box that was 8 inches (203 mm)×6 inches (152 mm)×10 inches (254 mm) with a side-wall thickness of 1.5 inches (38 mm). Each of the 5 walls of the open box were cut to provide 2 inch (51 mm)×2 inch (51 mm) samples, for a total of 48 specimens from each of the molded articles. The molded articles produced as described herein were molded in a Kurtz Ersa Corporation K68 HP5 Top-Line molding machine, available commercially from Kurtz Ersa Corporation, Kreuzwertheim, Germany. The molding machine was modified with custom software to enable the simultaneous venting during introduction of steam and foam particle introduction.

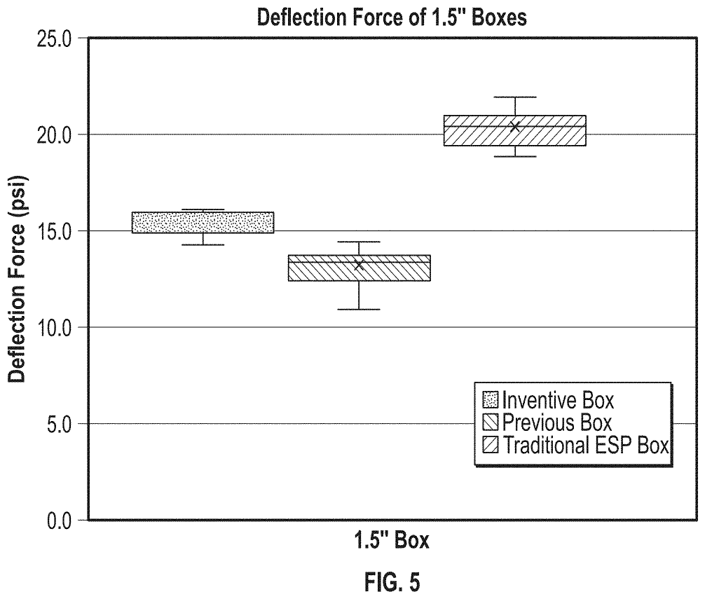

FIG. 5 is a chart depicting the deflection force of the 1.5 inch (38 mm) panels produced in this Example, as measured by ASTM D3575-14. The panels produced by the present method withstood greater deflection force with less variability among samples as compared to the molded articles produced as described in U.S. Pat. No. 10,688,698. Furthermore, the differences between the two are statistically significant as indicated by the p-value less than 0.05. The panels produced by the present method withstood lesser deflection force than the traditional EPS process, but the panels produced by the present method were formed from poly(lactic acid) and are therefore biodegradable. This reduced deflection force was accompanied by less variability among samples, representing a more uniform fusion throughout the molded article.

### Example 4: Comparison of Cycle Time, Steam Time, and ΔT with EPS Process

The method as described herein was implemented and compared to a standard EPS process to determine the benefits overall cycle time, steaming time, and ΔT. The results are presented in Table 2.

TABLE 2
Comparison of Cycle Time, Steam Time, and ΔT

| Traditional EPS Process | | | New Process with PLA foam | | | Comparison |
|---|---|---|---|---|---|---|
| | Time | % of | | Time | % of | Vs Traditional |
| Step | (sec) | Total | Step | (sec) | Total | EPS |
| Particle Fill | 7 | 11% | Steam + Particle | 2.5 | 11% | −4.5 sec |
| | | | Fill | | | |
| Hydraulics | 10 | 16% | Hydraulics | 10 | 44% | 0 sec |
| Direct Steam | 13 | 21% | Direct Steam | 1.2 | 5% | −11.8 sec |
| | | | Open to | | | |
| Cooling water | 3 | 5% | Atmosphere | 1.2 | 5% | −1.8 sec |
| Stabilization | 28 | 45% | Stabilization | 7 | 31% | −21.0 sec |
| Cycle Pause | 1 | 2% | Cycle Pause | 1 | 4% | +0.0 sec |
| Total Time | 62 | | Total Time | 22.9 | | −39.1 sec |
| Total Steaming Time | 10 | | Total Steaming Time | 3.7 | | −6.3 sec |
| Max Temp (° C.) | 110.1 | | Max Temp (20 C.) | 96.0 | | −14.1° C. |
| Min Temp (° C.) | 82.1 | | Min Temp (20 C.) | 86.0 | | 3.9° C. |
| AT (° C.) | 28.0 | | AT (° C.) | 10.0 | | −18.0° C. |

As illustrated in Table 2, the method of the present disclosure is nearly 40 seconds faster than a traditional EPS Process, requiring lower steam time and a lower ΔT, which corresponds to less energy consumption. By introducing steam during the foam particle introduction, the necessary direct steam can be reduced from around 13 seconds to around 1 or 2 seconds. Also noteworthy is lack of cooling water use in the new process. While conventional molding processes prevented the introduction of steam during foam particle introduction, typically motivated by a desire to prevent wasting steam, it has been unexpectedly discovered that the overall cycle time and steam time can be dramatically reduced, despite the potential for wasting steam by introducing steam during particle filling.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A method of making a molded foam article, comprising:
(i) wetting and heating foam particles introduced into a mold for an article without foam particle fusion; and then
(ii) applying a negative pressure cycle in which the foam particles are expanded and fused together to form the article; and then
(iii) removing the molded foam article from the mold.

2. The method of claim 1, wherein step (i) comprises introducing foam particles into the mold while simultaneously introducing steam into the mold.

3. The method of claim 1, wherein step (ii) comprises injecting steam into the mold.

4. The method of claim 1, wherein step (i) further comprises applying slight negative pressure cycle to the mold simultaneously with the introduction of the foam particles and the steam.

5. The method of claim 1, wherein step (i) comprises (a) introducing the foam particles into the mold, and then (b) introducing steam into the mold while venting the mold, wherein the venting is effective to prevent the foam particles from expanding or collapsing.

6. The method of claim 1, wherein:
steam heats the mold to a first temperature, and then
the mold, following filling of the foam particles, is cooled to a second temperature during the negative pressure cycle, and
the first temperature is from 5 to 25° C. higher than the second temperature.

7. The method of claim 6, wherein the first temperature is 10° C., 15° C., or 20° C. higher than the second temperature.

8. The method of claim 1, wherein the molded foam article has a thickness from about 0.3 inches to about 12 inches in at least one dimension.

9. The method of claim 8, wherein the method is effective to yield a molded article which has a greater flexural strength than a foam article molded using a conventional process, as measured by ASTM C203.

10. The method of claim 1, wherein the method is effective to yield a molded article which has greater deflection force than a foam article molded using a conventional process, as measured by ASTM D3575-14.

11. The method of claim 1, wherein the method is effective to yield a molded article which has greater fusion uniformity than a foam article molded using a conventional process.

12. The method of claim 1, wherein the molded article has a deflection variability of less than 8%.

13. The method of claim 1, which has an overall molding time that is at least 50% less than an overall molding time of a conventional expandable polystyrene molding process.

14. The method of claim 1, wherein steam is introduced into the mold at an angle effective to agitate the foam particles within the mold.

15. The method of claim 1, wherein no cooling water is used to cool the mold.

16. The method of claim 1, wherein the foam particles comprise homopolymers, graft polymers, or copolymers of poly(butylene succinate), poly(ethylene terephthalate), poly(lactic acid), poly(poly(hydroxy butyrate), poly(butylene terephthalate), poly(caprolactone), poly(butylene adipate terephthalate), poly(hydroxy alkonate), or blends thereof.

17. A molded article produced by a method comprising the steps of:
(i) wetting and heating foam particles introduced into a mold for an article without foam particle fusion; and then
(ii) applying a negative pressure cycle in which the foam particles are expanded and fused together to form the article; and then
(iii) removing the molded foam article from the mold.

18. The molded article of claim 17, wherein the foam particles comprise poly(lactic acid) and the molded articles is in the form of panels, edge protectors, box, lid or other molded shapes.

19. The molded article of claim 18, wherein the one more panels have a thickness from about 1.5 inches to about 12 inches.
